(19) United States
(12) Patent Application Publication
(10) Pub. No.: US 2014/0272825 A1
(43) Pub. Date: Sep. 18, 2014

(54) ELECTRONIC EDUCATION SYSTEM AND METHOD

(71) Applicant: Pamela Chambers, Scottsdale, AZ (US)

(72) Inventor: Pamela Chambers, Scottsdale, AZ (US)

(21) Appl. No.: 14/208,682

(22) Filed: Mar. 13, 2014

Related U.S. Application Data
(60) Provisional application No. 61/778,867, filed on Mar. 13, 2013.

(51) Int. Cl. G09B 17/00

(52) U.S. Cl. CPC G09B 17/003
USPC 434/178

(57) ABSTRACT

Aspects of the present disclosure generally relate to a system and method for educating one or more individuals, and in particular, an electronic education system and method that is capable of being used by one or more students to learn, improve, and/or enhance fundamental literacy skills. In various aspects, one or more elements such as pop-up menus, social media connections, web interfaces, and/or the like, may be provided that enable users, such as students, to engage in real-time, interactive computer-enabled instruction.

### CROSS REFERENCE TO RELATED APPLICATION

The present non-provisional utility application claims priority under 35 U.S.C. §119(e) to co-pending provisional application No. 61/778,867 entitled “Electronic Education System And Method,” filed on Mar. 13, 2013 and which is hereby incorporated by reference in its entirety.

### FIELD

Aspects of the present disclosure generally relate to a system and method for educating one or more individuals.

### BACKGROUND

Traditional methods of teaching, including the use of brick-and-mortar schools, have long proved of use in educating both youths and adults. Under some circumstances, additional education experiences for students, which include students of all ages, may be necessary and/or desired to improve or enhance their capacity and capabilities. For example, the use of a tutor (e.g., the teacher or an outside individual) is a well-known supplement to the conventional education experience. Other examples include extracurricular learning centers that can be designed to complement or augment the conventional education experience. However, some or all of these additional education experiences may not thoroughly engage students such that some or all of the students may not be encouraged or driven to participate in this additional education experience. Accordingly, some of these conventional extracurricular experiences may provide only minimal additional benefit to the students.

### SUMMARY

Aspects of the present disclosure include an electronic education system. The system includes at least one processor. The at least one processor is configured to automatically hyperlink, at least one term included in at least one page of a plurality of pages included in a book, to at least one selectable option of a reading resource menu. The hyperlinking is based on a learning ability of a user. The at least one processor is configured to display the hyperlinked at least one term during presentation of the at least one page on a reading display to enable access to the term. The at least one processor is configured to display a window corresponding to the at least one selectable option when the hyperlink is accessed.

Aspects of the present disclosure include an education method. The method is executable by at least one processor. The method includes automatically hyperlinking, at least one term included in at least one page of a plurality of pages included in a book, to at least one selectable option of a reading resource menu. The hyperlinking is based on a learning ability of a user. The method further includes displaying, using at least one processor, the hyperlinked at least one term during presentation of the at least one page on a reading display to enable access to the term. The method includes displaying, using the at least one processor, a window corresponding to the at least one selectable option, when the hyperlink is accessed.

Aspects of the present disclosure include non-transitory computer readable mediums encoded with instructions for performing electronic education. The instructions are executable by a processor and include serving a webpage comprising a reading display to present at least one book to a user, the book comprising a plurality of pages. The instructions include hyperlinking at least one term included in at least one page of the plurality of pages to at least one selectable option of a reading resource menu, based on the learning ability of the user. The instructions include displaying the hyperlinked at least one term on the reading display during presentation of the at least one page to enable access to the term. The instructions include displaying on the reading display, a window corresponding to the at least one selectable option, when the hyperlink is accessed.

### BRIEF DESCRIPTION OF THE DRAWINGS

The foregoing and other objects, features, and advantages of the present disclosure set forth herein will be apparent from the following description of particular embodiments of those inventive concepts, as illustrated in the accompanying drawings. It should be noted that the drawings are not necessarily to scale; however, the emphasis instead is being placed on illustrating the principles of the inventive concepts. Also, in the drawings the like reference characters refer to the same parts throughout the different views. The drawings depict only typical embodiments of the present disclosure and, therefore, are not to be considered limiting in scope.

FIG. 1 is a block diagram illustrating an education system computing environment, according to aspects of the present disclosure.

FIG. 2 is a block diagram illustrating a computing device, according to aspects of the present disclosure.

FIGS. 3-21 are screen shots illustrating various aspects of an education system, according to aspects of the present disclosure.

### DETAILED DESCRIPTION

Before any embodiments of the present disclosure are explained in detail, it is to be understood that the present disclosure is not limited in its application to the details of construction and the arrangement of components set forth in the following description or illustrated in the following drawings. Aspects of the present disclosure involve other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the present disclosure. Various modifications to the illustrated embodiments will be readily apparent to those skilled in the art, and the generic principles herein can be applied to other embodiments and applications without departing from embodiments of the present disclosure. Thus, embodiments of the present disclosure are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the present disclosure. Skilled artisans will recognize the examples provided herein have many useful alternatives that fall within the scope of embodiments of the present disclosure.

Some embodiments may include an electronic education system and method of use thereof. The electronic education system may be configured for promoting real-time computer-enabled instruction, interaction testing, and reporting for one or more users. As used herein, the term “user” refers to any individual, organization, or other entity that makes use of the electronic education system. The term “user” may refer to any form of student or pupil or it may refer to teachers, instructors, parents, guardians, etc. Accordingly, the term “user” can mean anyone/anything that accesses the system. In addition, the pronoun “she” is used throughout the following discussion; however, the use of this pronoun is not intended to be construed as limiting the use of the system to individual of any particular gender. Furthermore, although the following explanation of the electronic educational system is provided in the context of reading and literacy, any other subject can be used in place of reading. For example, the electronic education system can be implemented in the context of mathematics, biology, chemistry, social studies, etc.

Moreover, some elements of the electronic education system may include an application that can further include computer program code that is executable by a processor of a client or computer (e.g., personal computer, laptop, tablet, smart phone, personal digital assistant, or any other device that is capable of exchanging data using a network connection) and/or a processing unit of a server and can be accessed by a user or student (unless otherwise indicated, user and student are interchangeable) via the computer. The computer can be in communication with the server via a network to receive and transmit information through a web-based program controlled by the application. This information, such as user information, education-based content, and other program information, as further described below, can be stored on a computer-readable medium of the computer (e.g., a computer storage unit) and/or on a computer-readable medium of the server (e.g., a server database). In some embodiments, the entire application or a portion of the application can be stored on the computer. In other embodiments, the entire application or a portion of the application can be stored on the server and can be accessed by the computer when the server and the computer are connected via the network.

For example, FIG. 1 shows the electronic education system 100 according to some embodiments. The electronic education system can include a server or content source 112, which may include a hosting system, and a plurality of clients 102-106 (i.e., computers as defined above) that may all be connected via a network 110. The content source 112 may transmit computer-based information to the clients via the network 110.

Moreover, FIG. 2 shows an example of a computing device 200 that can be used as the content source 112 and/or one or more of the clients 102-106. The computing device 200 may include a processor 202 linked to a memory 204, a media/medium drive 206, and a mass-storage device 208 via a bus 210. For example, memory typically includes random access memory (RAM) and read only memory (ROM). ROM may include a Basic Input Output System (BIOS) including basic routines configured to start-up and operate the client. The media drive 206 may be a DVD-ROM drive, a CD-ROM drive, a floppy disk drive, a magneto optical drive, or other drive configured to read media and/or medium such as a DVD-ROM, CD-ROM, floppy disk, or magneto-optical disk. The mass-storage device 208 may be a conventional hard drive. Furthermore, the processor 202 may be configured to execute programs stored on mass storage device or media using portions of memory.

In addition, the computing device 200 may include additional components. For example, the client (e.g. clients 102-106) may include user-input devices, such as a keyboard 212 and mouse 214, as well as a display 216 and one or more speakers 218. As previously mentioned, some embodiments include a client that is configured as a smart phone. Accordingly, in some circumstances, the keyboard or other elements of the client may be a “pop-up” keyboard that only becomes visible to the user when the entry of text becomes necessary. The client may include a network interface such as a modem 220, antenna, or other device that enables the client to communicate via the network.

In addition, the content source/server may include one or more computer devices similar to the one shown in FIG. 2. For example, the content source may include a host server configured to run a server application that can be used with some embodiments of the electronic education system. Some examples of server applications include web servers, file servers, proxy servers, mail servers, and video servers, chat servers, etc. Moreover, it should be understood that the electronic education system may include more than one server. Furthermore, the network may be a Wide-Area Network, such as the Internet, or the electronic education system may be implemented within a local-area network, a virtual private network, or another suitable computer network. Additionally, as shown in FIG. 1, the electronic education system can include one or more clients.

In some embodiments, the electronic education system may be implemented as a web page system. In other words, the electronic education system may be configured to function as a web page that can be accessed when the user instructs the client to execute a browser application to request, access, view and provide screens (web pages) that are transmitted by the content source/server via the network. However, in other embodiments, the electronic education system may be implemented in other configurations, such as, but not limited to, a program saved on the memory of the client that is executed by the processor of the client.

Referring now to FIG. 3, when the user instructs the client to execute the browser application to access the content source, a home page 300 may be initially displayed on the display of the client (e.g., a screen or monitor). As described in greater detail below, in some embodiments, access and use of the electronic education system can rely on a membership-based access (i.e., using a user-created account with a password). For example, the access can be subscription based or the system may be accessible without the requirement of a fee submission (e.g., monthly, weekly, per use, a one-time fee, etc.). In some embodiments, regardless of the configuration of access to the system, the home page may be initially displayed and the user may then navigate to other portions of the system.

In some aspects, the home page 300 can include multiple elements. For example, as shown in FIG. 3, the home page may include a social media connectivity region 302, an access region 304, a main menu 306, a book-shelf region 308, a newsletter link 310, and other features. Specifically, once the user accesses the home page 300, she may use the access region to provide her membership information or sign-up for a membership to use the electronic education system. In particular, the user may follow a Sign In link (for a user that has already created a membership account) or the user may follow a Join Now link to create a membership to use the electronic education system. In addition, once the user reaches the home page, the user may share her experience with other users or non-users using the social connectivity region. For example, the user may access a TWITTER® or FACEBOOK® account or access YOUTUBE® by selecting, clicking, and/or otherwise actuating the links provided in the social media connectivity region of the home page.

In addition, the main menu 306 of the home page 300 can function as a primary navigation guide for the user throughout use of the electronic education system. The main menu 306 may include links to several pages to which the user can navigate. For example, the main menu 306 can includes links to a Books page, a Bookalicious Blog page, an Ask Pam page, a Career Day page, and/or a Connect page. In addition, in other embodiments, the main menu 306 can include the above-mentioned links in addition to links to other pages that may be useful or interesting to the user. As shown throughout the figures, the main menu 306 may be displayed on some or all of the web pages associated with the electronic education system to enable straight-forward navigation by the users.

As shown in FIG. 3, the book-shelf region 308 may contain one or more images that represent books, periodicals, or other reading materials. As used herein, the term “books” encompasses any type of reading, viewing, and/or listening materials. As mentioned before, the electronic education system may be used by users (e.g., students) to develop, improve, enhance, or otherwise perfect learning capabilities. In some embodiments, the book-shelf region of the home page can be employed by users to select one or more books to develop and/or improve reading-associated capabilities (e.g., reading comprehension, pronunciation, vocabulary, etc.). In some aspects, the images of books can be configured and arranged in a regular pattern (i.e., as through the books were books on a book shelf) or they can be arranged in irregular patterns. Moreover, in some embodiments, the book-shelf region 308 may be partially or completely filled with images of books, as shown in FIG. 3. As a result, the user has a plurality of options so that she can select the appropriate books. In addition, in some embodiments, the number of books accessible by the user may exceed the capacity of the book-shelf region 308 on the home page 300. As a result, the home page 300 may include links for a Previous Bookshelf and a Next Bookshelf that, when clicked or otherwise actuated by user, can display additional books from which the user can choose to read and review.

In addition, the book-shelf region 308 may include other functionalities. In particular, as shown in FIG. 3, the user may preview the reading materials prior to making a selection. For example, in some embodiments, the user may employ a navigational device (e.g., a cursor 312, as represented by the hand in FIG. 3) that can initiate the preview process. In particular, the user can move the navigational device over a particular book, such as the upper left-most book shown in FIG. 3, to generate a preview box 314. For example, in some aspects, the user may need to only cause the navigation device to hover over the reading material to cause the browser application to generate the preview box 314. In other aspects, the user may have to click on or otherwise actuate the book to generate the preview box 314.

Regardless of the manner of generating the preview box 314, this element includes information that can be employed by the user to select the appropriate books. For example, the preview box may function as a “pop-up window” within the display of the client and include information related to the book such as the title, the name of the author, an expanded image of a cover of the book, and brief and/or extended synopsis or summary of the book. As a result, the user can process the information contained in the preview box 314 to determine whether she would like to read this particular book or other books. In addition, should the user wish to read and/or review the previewed materials, the preview box 314 includes links to Read the Book 316 or Buy the Book 320. Specifically, if the user is interested in this book, she can click or otherwise select one of these two links to read and/or review this book. In addition, the preview box 314 includes an Exit symbol 318 that the user can employ to close the preview box 316 without the need to select the links to Read the Book 316 or Buy the Book 320. In other words, should the reading material be unappealing to the user, she can select the Exit symbol 318 to close the preview box 314 so that other books can be previewed.

Furthermore, the home page 300 can include additional elements. As shown in FIG. 3, the home page may include an area for the logo 312 of the provider/administrator of the electronic education system. Moreover, the home page 300 may also include a welcome message and information regarding the benefits and use of the electronic education system. For example, the home page 300 may include both written information and a video message conveying the benefits offered to users of the electronic education system. Further, the home page 300 may also include a Free Book link 322. As mentioned above and discussed in further detail below, the books in the book-shelf region 308 may require either a membership associated with the electronic education system or may require a flat fee to read the book for non-members. However, the Free Book link 322 may be employed by users who wish to read a book without cost. For example, a publisher may wish to promote a new book such that the publisher could provide the book the system for free distribution.

In addition, the home page 300 can also include the newsletter link 310. In particular, an administrator, owner, and/or proprietor of the electronic education system may prepare and circulate a newsletter (e.g., a document that contains pertinent information about the electronic education system and uses thereof) on a regular or irregular basis to members or self-designated non-members. For example, the user may select the newsletter link 310 and a newsletter sign-up frame 402 will be displayed, as shown in FIG. 4. The newsletter sign-up frame 402 may include fields into which the user enters biographical information such as their name and e-mail address. Once the user submits the requested information, the user can select the Sign Me Up! link to indicate to the administrator that the user wishes to receive the newsletter. Overall, the home page 300 is the initial page through which the user engages the electronic education system 100. The following discussion will explain steps taken by the user to navigate from the home page to other pages associated with the electronic education system.

As shown in FIG. 5, the client may display the Books page 500 when the user selects the Books link in the main menu 306. In brief, the Books page 500 can exhibit a similar configuration to the home page (e.g. home page 300). Specifically, the Books page 500 can also include the main menu 306 (for easy navigation), the book-shelf region 504, the social media connectivity region 506, and the access region 508. Moreover, the Books page 500 may also include an introductory section 510 and a books engine 512. In particular, the introduction section may include a brief or extended explanation of the information contained within the Books page that may be accessed by the user.

In addition, the books search engine 512 may include one or more fields into which the user can input text (i.e., via the keyboard) related to a book that the user may wish to read or review. For example, a user wishing to read an adventure book can type the word “adventure” (or synonyms thereof) into the search engine field and select the Search link. The books search engine 512 can be configured to return a list of books and other reading materials that are categorized as adventure-style materials. Furthermore, the books search engine 512 can include a categories section 514. As shown in FIG. 5, the categories section 514 organizes books by category. For example, the categories section 514 can include categories such as, but not limited to adventure, outdoors, humor, horror, non-fiction, etc. As a result, the user can select one or more categories to search and then enter text into the search engine field for a more-refined search of the books associated with the electronic education system. Also, the Books page may include a link to an Additional Books window 516. Specifically, in some embodiments, the link may be positioned generally adjacent to the categories section so that if a category that interests the user is not listed in the categories section, the user can select the link and the Additional Books window 516 will appear in the display of the client. As shown in FIG. 5, the Additional Books window 516 may include a field into which the user can enter text regarding additional types of books that the user would like to be able to access through the electronic education system. After submission of this information to the electronic education system, an administrator can determine whether to add books of that type for reading by users.

Referring now to FIG. 6, after the user selects a book from the home page and/or the Books page, the user is directed to a Reading page 600. For example, the user can select a book from the book-shelf region (e.g. 308 or 504) prior to being directed to the Reading page 600. Regardless of the manner in which the user reaches the Reading page 600, this page includes a status box 602, a reading display 604, and an author section 606. In addition, in some embodiments and as shown in FIG. 6, the system may request that the user sign-in or create a membership account via a Log-In display 608. Specifically, unless the user is attempting to view the Free Book (discussed above), if the user has not already entered her membership information via the links in the access region of the home page or the Books page, the system may prompt the user to do prior to displaying the text of the book. As a result of requiring the user to have an account, the system can track the user's reading habits and abilities to monitor the user's progress, as discussed in greater detail below.

After the user enters her log-in credentials into the fields of the Log-In display 608 (or creates a new account, as discussed below), the user can more fully view the Reading page 600. If the user has previously started reading this selected book, the status box 602 may reflect statistics associated with the user's prior reading sessions. For example, the status box 602 may include information such as the percent complete (i.e., what percentage of the book the user has read), whether the user has accessed one or more pertinent vocabulary terms, and an assessment of the user's reading comprehension ability. Moreover, the status box 602 can include any other indicia that may be useful for a user or entities affiliated with the user (e.g., one or more parents or guardians, instructors, teachers, etc.) to determine the user's literacy progress.

In addition, the Reading page 600 may also include the author section 606. As shown in FIG. 6, the author section 606 includes information about the author. For example, the author section 608 may include a multi-media display about the author (e.g., biographic or autobiographic) so that the user can learn more about the individual who wrote the book that the user has selected. The author section may also include a Similar Books subsection 610 in which books by the same author or books on a related topic that are not necessarily written by the same author are displayed. In addition, the author section 608 may also include a Journal Entries subsection in which posts (e.g., blog posts) prepared by the author may be available for the user to review. In some embodiments, the blog posts may be written by other individuals (including other users) on a topic related to the book selected by the user.

The Reading page 600 also includes the reading display 612. As shown in FIG. 6, the reading display 612 may be an image of a cover or a first page of the selected book. Moreover, the reading display 612 may also include information related to the book, such as the title, the name of the author, the subject, etc. Once the user decides to move forward with reading the book, the user can select or click on a portion of the book illustrated in the reading display 612 to begin reading. For example, as shown in FIG. 6, the user can move the cursor to a corner of the page on the reading display to advance the page to begin reading. In addition, in some embodiments, if the user has previously started reading or reviewing this book, the system can either display the page on which the user stopped reading during the last session or when the user clicks on the corner of the page, the user can be automatically directed to the last page that she read. Moreover, the Reading page 600 can be individualized for each user and each book. Accordingly, if the user stops reading book A and begins reading book B, when the user selects book B, the Reading page 600 displayed can be customized to that particular book (e.g., information about the author and the user's status, as relevant to that book).

The Reading page 600 may also include other elements. For example, as shown in FIG. 6 and later figures (e.g. FIG. 7A as 700), the Reading page 600 may also include a reading resource menu. In particular, the reading resource menu may include options that the user can select on a book-by-book basis. Specifically, the reading menu can include links to items such as vocabulary terms, phonics lessons, self-assessments, and reading voices (e.g., for audio books). As discussed in greater detail below, the reading resource menu can be employed by the user to more completely immerse her in the reading experience and gain more from the experience based on the multiple learning aspects accessible via the electronic education system.

As shown in FIGS. 7A and 7B, the Reading page 700 can be employed by the user to read the selected book and learn from the experience. Once the user begins reading and/or reviewing the book (e.g., via clicking on a corner of one of the pages), the pages of the book can be displayed to the user. Specifically, images of the pages of the book can be displayed in a manner similar to that of an actual book (i.e., left page and right page displayed in the same view) or the images of the book can be displayed in other formats (e.g., one page at a time or one continuous page of text). As shown in FIGS. 7A and 7B, the system may display the book in a manner to simulate an actual, physical book.

However, the reading display includes resources that are unavailable to the user when the user is reading a conventional book. For example, at least a portion of the text of the book can by hyperlinked. As shown in FIGS. 7A and 7B, the word “enim” 706 is hyperlinked so that the user can select the word to learn more about it. In particular, a pop-up window can appear and the electronic education system can be configured and arranged to instruct the client to emit an audible pronunciation of the hyperlinked term. As a result, the user will be able to associate the written word with the pronunciation. In addition, the pop-up window may also include information such as phonics rules that are associated with that particular word (e.g., when “c” is followed by “e, i, or y,” it usually has the soft sound of “s.”) or a written description of how to pronounce the hyperlinked word.

In some embodiments, the words or terms chosen to be hyperlinked can be substantially or completely automatically performed by the electronic education system. In one embodiment, the system may include one or more algorithms that are configured to assess key terms as these terms pertain to users with certain learning abilities and levels such that the system can determine which terms would be the most advantageous for the user to learn. More specifically, a user may provide a reading level in his/her membership and/or profile that quantifies and/or qualifies the user's reading capabilities. Alternatively, the education system may calculate a user's reading level by monitoring the type of books the user is reading, the amount of time a user takes to complete a book, the types of words or terms included within a particular book a user is reading, and/or the like.

Once a reading level for a particular user has been determined or otherwise calculated, the reading level may be used by the education system to determine which words or terms should be hyperlinked in a given book that the user may be reading, was reading, etc. For example, the words or terms may be hyperlinked according to the number of syllables in a word. More specifically, in one embodiment, the algorithm may hyperlink words with a high syllable count for users corresponding to a high reading level. Alternatively, in another embodiment, the algorithm may hyperlink words with a low syllable count for users corresponding to a lower reading level. In other embodiments, a system administrator can select the words or terms for hyperlinking and expanded learning. Other words or terms may be hyperlinked according to various other grammatical rules, sentence structures, and/or the like.

In addition, the user can employ the reading resource menu before, during, or after reading the book. As shown by the arrows 720-724 in FIG. 7B, when the user selects options from the reading menu, different pop-up windows will appear in the display to engage the user. For example, when the user selects the vocabulary words link, a pop-up window that includes one or more key terms associated with this particular book (or similar books) can appear. As a result, the user reviews these key terms to enhance or develop her vocabulary in the context of the subject matter of the book that she is or was reading. Next, when the user selects the phonics lessons link, a pop-up window appears in the display that contains key phonics rules and learning tips that the user can employ to both understand the text that she is reading and learn the rules for applications not encompassed by the book (i.e., learn the phonics lessons for use in everyday life). In addition, the phonics lesson pop-up window may include one or more audio icons that the user can select to cause the client to emit sounds conveying the pronunciation of the relevant terms.

Also, when the user selects the self-assessment link or “did you understand” link, a pop-up window appears in the display that contains one or more inquiries/questions about the information conveyed by the book. For example, the pop-up window includes one or more multiple-choice questions that test whether the user comprehends the subject matter of the book. In addition, if the user wishes to answer the question at a later time, the user can select the save for later link to postpone the need to answer the question. In some embodiments, the electronic education system can be configured to automatically display the inquiries/questions on a regular or irregular basis to assess the user's comprehension (e.g., one or more “pop quizzes”). Finally, in the case of books with corresponding audio recordings, when the user selects the choose voice link, a pop-up window is displayed which includes multiple choices for a voice and language. For example, as shown in FIGS. 7A and 7B, the user can select the language in which book is read or the sex of the voice reading the book or pronouncing the key terms.

In addition, the user can also select a My Progress link to cause the system to display the status box discussed above. For example, the information conveyed in the status box can be updated in real-time or near real-time such that the user can constantly assess their progress and measured comprehension. In particular, as the reader advances through the pages of the book, the percent complete will grow and as the user correctly answers questions associated with the self-assessment inquiries discussed above, the reading comprehension score will increase. Similarly, after the user access the key vocabulary terms by clicking on the vocabulary words link, the status box will also note the user's progress in this regard. Moreover, should the user wish to close the status box, the user can select the exit symbol in the corner of the status box.

While reading the book, the Reading page 700 may also have other options for the user. For example, in the case of books that are designed in a “choose-your-adventure” style that include options for the user to choose while reading, the electronic education system can include one or more pop-up windows that pose choices for the user. In particular, when the user reaches a key decision point in the book, the system can cause a pop-up window to be displayed that includes options for the user to select what occurs next in the story of the book. After the user makes the selection, the system can display the appropriate section of the book for the user's continued reading.

In addition, the Reading page 700 and the reading display may also include other options. In particular, the Reading page 700 may include a Write in Journal link that the user can select to access her electronic journal. Specifically, when each user creates a membership account, the electronic education system can create an individualized electronic journal for each user that may be secured such that only the user and other designated individuals can access (e.g., an administrator). For example, when the user selects the Write in Journal link, the system can display a pop-up window with multiple fields that allow the user to enter her personal thoughts about the book or other feelings and select whether this journal entry is intended to be public or private. In addition, the pop-up window may also include one or more potential categorizations of the journal entry that the user can select to organize her journal. Once complete, the user can select the publish link to post the journal entry for either a public, semi-public, or private audience to view. As discussed in greater detail below, some or all of the journal entries prepared by the user can be viewed on the Bookalicious Blog page.

Next, the Reading page 700 and reading display 704 may also include an Ask link 726 (labeled “Ask Pam” in FIGS. 7A and 7B). In some embodiments, the Ask link 726 can be employed by the user to pose one or more questions or inquiries to the administrator or other qualified individuals about the book or other related/unrelated matters. For example, when the user selects the Ask link 726, the system can display a pop-up window that includes a field into which the user enters her question(s). Once complete, the user can select the Ask Now link to submit her questions for answering. The pop-up window may also include a View Answers link that the user can select to navigate to a page that includes multiple questions and answers, as described in further detail below. In addition to the View Answers link, the user can also select the Ask Pam link 726 in the main menu to view other questions and answers.

Further, the Reading page 700 and reading display 704 may also include a Buy Hardcover link. In some embodiments, if the user desires to own a physical copy of the book that she is reading, the user can select the Buy Hardcover link and place an order through the electronic education system to purchase the book. As a result, after transmitting payment, the user can receive a physical copy of the book that she read on the Reading page.

In addition, although not shown in the figures, the electronic education system may also be configured to engage parents, guardians, or instructors associated with the users. For example, once a user completes her reading of a book, the system may transmit one or more questions (e.g., three questions) to parents, guardians, or instructors associated with the user so that these individuals can engage the user and discuss what the user gained from her reading experience.

Taken together, all of the options and tools available to the user on the Reading page enable interactive learning on the part of the user. In particular, the user is not only able to read a book and learn in the traditional sense (i.e., through the reading experience), but the user is also able to assess her own comprehension and learn associated vocabulary and phonics in an in-context environment.

Referring now to FIG. 8, the user can also select the Bookalicious Blog link 802 in the main menu 804 (e.g. equivalent to main menu 306). Once the user selects the Blog link 802, the system displays a Blog page 800, as shown in FIG. 8. For example, before, after, or while the user is reading a book, the user can navigate to the Blog page 800 to review blog or journal entries (referred to as “entries” herein) posted by the user or other users/administrators. The Blog page 800 may include a series of entries with only a portion of the individual entries displayed. As shown in FIG. 8, the entries can be organized by category. Some or all of the entries associated with a particular book or a particular theme can be grouped into a category and displayed when the user selects that category. Moreover, some or all of the entries can include biographical information about the author of the entry (e.g., name, username, date posted, avatar, etc.) so that the user can decide which entry to read. In addition, the Blog page 800 can also include a search engine 806 so that the user can look for particular entries related to a desired topic. Furthermore, the Blog page 800 can include a listing of some or all of the categories 810 under which users or administrators post and organized entries. For example, if a particular set of entries associated with a category is not of interest to the user, she can select another category that is of greater interest.

If the user decides to read an entry, the user can select entry of interest by clicking on the title of the entry or a Read More link 808 included with the entry. As shown in FIG. 9, if the user selects an entry, the system will display that entry on an Entry page 900, which includes the entire text of the entry, the title/name of the entry, the name of the author of the entry, and methods of sharing the entry with others. For example, the user can select the share icon to disseminate the entry via a method of social connection (e.g., a tweet, an SMS text message, a link in another blog post, etc.) or the user can select the e-mail icon to e-mail the entry or a link to the entry to an e-mail address. In addition, the Entry page 900 can include a list of related entries or posts that the user can select or a field into which the user can type comments. Moreover, the Entry page 900 can also include one or more comments that have been previously posted by users regarding the entry or subject matter related to the entry. In some embodiments, after attempting to leave comments, the comments entered by the user can be reviewed by an administrator to ensure the applicability and appropriateness of the comments. Overall, the learning experience of the user can be further improved by viewing and analyzing the entries on the Blog page because the user can gain valuable insight into the views of other users regarding the books and related subject matter.

Referring now to FIG. 10, the user can select the Ask Pam link to be directed to the Ask Pam page 1000. In particular, the Ask Pam page 1000 can be an organized listing of questions posed to one or more administrators or moderators. Accordingly, the Ask Pam page 1000 can be known by any other name that can be useful for the user. For example, the Ask Pam page 1000 includes a list of questions posed by users or other individuals and answers posted by the administrator or moderator. In addition, these questions and answers can be public for all users or other individuals to view. Moreover, each question and answer can be associated with a particular category (as determined by the user and/or the administrator) so that the user can filter the questions and answers by category. As a result, the user can more readily access the questions and answers that she wishes to read. The Ask Pam page 1000 also includes a search field into which the user can enter terms related to a particular category or key word that the system can use to filter to find the most relevant questions and answers.

As shown in FIG. 11, an administrator Ask Pam page 1100 can be similar to the user-accessible Ask Pam page 1000. For example, the administrator Ask Pam page 1100 can include a similar configuration, but can include additional functionalities. In particular, the administrator Ask Pam page 1100 can be restricted to only those individuals who function as system administrators or moderators. In addition, the administrator Ask Pam page 1100 may include questions without answers (i.e., questions that the administrator has yet to answer) and an Action column 1102. For example, the Action column 1102 includes one or more options (e.g., view the question and answer, edit the question or answer, and/or delete the question and/or answer) so that the administrator can control which questions and answers are available for general viewing. Moreover, the Action column 1102 allows the administrator to remove older questions and answers that may no longer be of use to the user population.

Next, the user can select the Career Day link in the main menu to learn about careers. As shown in FIG. 12, when the user selects the Career Day link, the system will display the Career Day page 1200. In particular, the Career Day page 1200 can include a list of careers with information about each career. For example, as shown in FIG. 12, each career can be associated with a multi-media display (e.g., a video) such that the user can select the career and view the display to learn more about the career. In some embodiments, the multi-media presentation can be an informational video in which a well-known individual associated with that particular career provides facts about that career. In other embodiments, the display may include reading materials for the user to review to learn more about the career. In addition, in some embodiments, each month, day, week, year, etc., a certain career can be emphasized to draw attention thereto (e.g., a career-of-the-month feature). As shown in FIG. 12, the Career Day page 1200 may also include an Additional Career link 1202 that, when selected by the user, will cause a pop-up window 1204 to be displayed. The pop-up window may include a field into which the user can enter the name of a career that may not now be included in the list of careers, but is a career that the user wishes to learn more about. As a result, the administrator can receive this information and, if applicable, can attempt to assemble a career profile for the particular career and post this career profile to the Career Day page 1200.

As shown in FIG. 13, the user can select the Connect link in the main menu to be directed to the Connect page 1300. For example, the Connect page is configured to enable the user or a person affiliated with the user (e.g., a parent or guardian) to attempt to locate a near-by service provider or other business/person. The Connect page 1300 may include an explanatory area that provides the user with information about the services associated with the Connect page 1300, as well as an explanatory video display. In addition, the Connect page 1300 includes a Request area 1302. As shown in FIG. 13, the Request area 1302 includes fields and/or drop-down lists/categories regarding the type of connections that the user may be seeking. For example, if the user is attempting to locate a child psychologist and receive a price quotation from the psychologist, the user can select “child psychologist” and enter her zip code. As a result, the electronic education system can process the request and determine whether there is a child psychologist within a pre-determined distance.

As shown in FIG. 14, once the user inputs the requested information into the fields of the Request area and selects a Search Now link, the system can display a Connections Results page 1400 in which one or more service providers are displayed. If there are sufficient numbers of service providers listed on the Connections Results page 1400, this page may include multiple fields into which the user enters additional information to aid the service provider in assembling a price quotation. After receiving the requested information, the system can transmit the information to the service provide who can then provide the user with a price quote regarding the requested services. In addition, the Connections Results page 1400 may include a Request Another Quote area 1402 where the user can submit information to obtain a quote for a different type of service provider or another geographical region.

In some embodiments, the administrator of the electronic education system can enter into relationships with one or more service providers (e.g., fee-based or non-fee based relationships) to populate the lists of service providers. For example, the administrator may evaluate the quality of the service provider to ensure that the service provider meets the standards and requirements imposed by the administrator. As a result, the user can be assured that the service providers are suitable businesses/individuals.

In some embodiments, the web page system that embodies the electronic education system may include additional features. As shown in FIGS. 15 and 16, pages that include information that may be of interest to some or all users can be displayed. For example, the system can display a Magic Shows page 1500 that includes information that users can read and review to learn the practice of magic. In particular, the Magic Shows page 1500 can include both written instructions about one or more magic tricks, as well as, or in place of a multi-media demonstration of the magic trick. In addition, the Magic Shows page 1500 may include links to other magic tricks that users can learn about via the system. Similarly, as shown in FIG. 16, the user can also choose to view a Cooking page 1600, which includes information relevant to one or more recipes, cooking techniques, measurement techniques, and/or food safety. For example, as shown in FIG. 16, the Cooking page 1600 can include an assessment area that the system uses to ask relevant questions to the user about the subject matter. In other embodiments, the electronic education system can include similar pages that convey subject matter that may be both interesting and educational for the users.

As previously mentioned, in some embodiments, the electronic education system can be a membership-based system. As shown in FIG. 17, the user can be directed to a Membership Information page 1700 when the user selects the Join Now link in the access region on the home page or any other page associated with the system. The Membership Information page 1700 can include prices associated with different membership levels available to access the electronic education system. In particular, the Membership Information page 1700 can display information such as cost, available features, and frequently asked questions that an individual can weigh and consider when acquiring a membership.

In some embodiments, the system can include three different levels of membership. For example, the system can include a student-level membership, a teacher-level membership, and an administrator-level membership. Moreover, each of these levels of membership may have different privileges, rights, and costs. For example, a student-level membership may only come with rights to be able to view and edit its own profile. However, a teacher-level or administrator-level membership may have access to multiple associated student-level memberships.

As shown in FIGS. 18 and 19 and by way of example only, pages associated with teacher/administrator-level memberships can exhibit a different appearance relative to pages associated with users having a student-level membership. In particular, as shown in FIG. 18, a teacher/administrator-level membership includes a page 1800 that details each of the teacher's/administrator's subscribers/associated users (e.g., students in the teacher's classes). Moreover, the information associated with each of the subscribers can include the subscriber's name, their e-mail address, the expiration date of the subscriber's account, and the last activity using the subscriber's account. In addition, the teacher/administrator-associated page 1800 includes information about the particular account, such as the subscription level, the name of the organization, an associated e-mail address, etc. On the other hand, as illustrated by FIG. 19, a subscriber/user-associated page 1900 includes fewer administrative tools. In particular, the subscriber/user-associated page includes information about the books that the user has read or is now reading. In addition, the subscriber/user-associated page 1900 may include a global status box that includes the user's cumulative progress data.

Accordingly, the users/subscribers can focus on the education experience and the teachers/administrators can focus on the organization and content of the system. In particular, the teachers/administrators can select particular books in which the users/students are interested and/or required to read. Moreover, the teachers/administrators can monitor the users' progress over time. In addition, in some embodiments, some memberships may be at least partially paid for by other parties/individuals. For example, in some embodiments, an educational institution, such as a school or entire school system may purchase a membership that is associated with multiple subscriber/student-level memberships (e.g., an administrator-level membership). As a result, the educational institution can expand its resources to pay at least a portion of the subscriber/student-level memberships associated therewith. Correspondingly, the students and families of the student can take full advantage of some or all portions of the electronic education system without the concern for some or all of the costs associated with membership.

Furthermore, during or after the user acquires a membership (regardless of membership level), the user can elect to donate a portion of the membership fees to a charity of the user's choosing. As shown in FIG. 20, one or more organizations (e.g., charitable organizations) can be listed on a Donation page 2000 and the user can elect one or more of the organizations to receive a portion of fees associated with the user's membership. For example, the Donation page 2000 can include multi-media displays for some or all of the organizations so that the user is able to determine which organization(s) should receive a part of her fees. In some embodiments, the administrator can pre-select certain organizations prior to final selection by the users.

In addition, as shown in FIG. 21, after the user selects a membership and creates a profile, the user can be directed to a Personalized page 2100 each time she enters her log-in credentials. In particular, the Personalized page 2100 includes information that pertains only to that particular user, regardless of which membership level the user acquired. For example, the Personalized page 2100 includes a list of some or all of the books that the user has read or is reading. In addition, the Personalized page 2100 includes a list of some or all of the questions submitted using the Ask Pam links described above and a list of some or all of the journal entries submitted by the user. This page also includes administrative information about this particular account in a My Account Details region 2102. In addition, the Personalize page 2100 can also include information regarding any hardcover books that the user purchased using the Buy Hardcover link discussed above.

Furthermore, the information contained on the Personalized page 2100 can be expanded upon by user-based navigation. In particular, as shown in FIG. 21, the user can select some or all of the above-mentioned elements of the Personalized page 2100 to obtain further information. For example, the user can select a particular book and a status box containing the user's progress as related to that book will be displayed for review. Moreover, the user can also access the book and continue reading in a manner similar to the one described above with respect to FIGS. 7A and 7B by selecting the Continue Reading link in the status box. Similarly, the user can select one or more of the questions that she has submitted and have the question and answer displayed in a pop-up window. Moreover, the user can also determine the details associated with a particular hardcover-book order by selecting the order and viewing the information in a pop-up window.

Overall, at least some embodiments of the present disclosure offer improvements relative to conventional education systems. For example, many or all conventional education systems (electronic or otherwise) do not offer a comparable encompassing learning experience exhibited by some embodiments of the present disclosure. In particular, many conventional education systems do not offer on-line reading capabilities in connection with real-time or near real-time progress reports and interaction between students (i.e., users) and teachers (i.e., administrators or teachers). As a result of facilitating this interaction, the electronic education system provides an interesting and dynamic environment for the development, improvement, and honing of literacy skills. Moreover, the interplay between the users and the system provides instructions/interactions that are explicit, systematic, diagnostic, and multisensory to stimulate the users' senses and interests, which engages the users to drive their interest in reading.

Embodiments of the present disclosure may be practiced with various computer system configurations including hand-held devices, microprocessor systems, microprocessor-based or programmable consumer electronics, minicomputers, mainframe computers and the like. Aspects of the present disclosure can also be practiced in distributed computing environments where tasks are performed by remote processing devices that are linked through a wire-based or wireless network.

With the above embodiments in mind, it should be understood that the embodiments of present disclosure can employ various computer-implemented operations involving data stored in computer systems. These operations are those requiring physical manipulation of physical quantities. Usually, though not necessarily, these quantities take the form of electrical or magnetic signals capable of being stored, transferred, combined, compared and otherwise manipulated.

Any of the operations described herein that form part of the invention are useful machine operations. The present disclosure also relates to a device or an apparatus for performing these operations. The apparatus may be specially constructed for the required purpose, such as a special purpose computer. When defined as a special purpose computer, the computer can also perform other processing, program execution or routines that are not part of the special purpose, while still being capable of operating for the special purpose. Alternatively, the operations may be processed by a general purpose computer selectively activated or configured by one or more computer programs stored in the computer memory, cache, or obtained over a network. When data is obtained over a network the data may be processed by other computers on the network, e.g. a cloud of computing resources.

The embodiments of the present disclosure can also be defined as a machine that transforms data from one state to another state. The data may represent an article, that can be represented as an electronic signal and electronically manipulate data. The transformed data can, in some cases, be visually depicted on a display, representing the physical object that results from the transformation of data. The transformed data can be saved to storage generally or in particular formats that enable the construction or depiction of a physical and tangible object. In some embodiments, the manipulation can be performed by a processor. In such an example, the processor thus transforms the data from one thing to another. Still further, the methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

Various aspects of the present disclosure may be embodied as computer readable code on a computer readable medium. The computer readable medium may be any data storage device that can store data, which can thereafter be read by a computer system. Examples of the computer readable medium include hard drives, network attached storage (NAS), read-only memory, random-access memory, FLASH based memory, CD-ROMs, CD-Rs, CD-RWs, DVDs, magnetic tapes, other optical and non-optical data storage devices, or any other physical or material medium which can be used to tangibly store the desired information or data or instructions and which can be accessed by a computer or processor. The computer readable medium can also be distributed over a network coupled computer systems so that the computer readable code may be stored and executed in a distributed fashion.

Although the method operations were described in a specific order, it should be understood that other housekeeping operations may be performed in between operations, or operations may be adjusted so that they occur at slightly different times, or may be distributed in a system which allows the occurrence of the processing operations at various intervals associated with the processing, as long as the processing of the overlay operations are performed in the desired way.

It will be appreciated by those skilled in the art that while the aspects of the present disclosure have been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein.

What is claimed is:

1. An electronic education system comprising:
at least one processor to:
based on a learning ability of a user, automatically hyperlink at least one term included in at least one page of a plurality of pages included in a book to at least one selectable option of a reading resource menu;
display the hyperlinked at least one term during presentation of the at least one page on a reading display to enable access to the term; and
display a window corresponding to the at least one selectable option, when the hyperlink is accessed.

2. The system of claim 1, wherein the at least one processor is further configured to:
serve a webpage comprising the reading display to present at least one page of the book; and
process membership information corresponding to the user to generate a unique membership account corresponding to the user and authorize the user to access the webpage.

3. The system of claim 2, wherein the at least one processor is further configured to generate an electronic journal corresponding to the user when the membership account is generated.

4. The system of claim 1, wherein the reading display comprises the reading resource menu, wherein the at least one selectable option corresponds to the at least one book, and wherein the at least one selectable option includes at least one of vocabulary terms, phonics lessons, self-assessments, reading voices, and choose-your-adventures.

5. The system of claim 1, wherein the reading display further comprises an Ask link interface comprising one or more data fields to receive one or more questions corresponding to the at least one book as input from the user.

6. The system of claim 1, wherein to automatically hyperlink, at least one term included in at least one page of the plurality of pages to at least one selectable option of a reading resource menu, based on the learning ability of the user comprises:
determining a reading level of the user; and
identifying the term based on the reading level.

7. The system of claim 1, wherein the window is a pop-up window external to the reading display.

8. An education method comprising:
based on a learning ability of a user, automatically hyperlinking at least one term included in at least one page of a plurality of pages included in a book to at least one selectable option of a reading resource menu;
displaying, using at least one processor, the hyperlinked at least one term during presentation of the at least one page on a reading display to enable access to the term; and
displaying, using the at least one processor, a window corresponding to the at least one selectable option, when the hyperlink is accessed.

9. The method of claim 8, further comprising:
serving a webpage comprising the reading display to present at least one page of the book; and
processing membership information corresponding to the user to generate a unique membership account corresponding to the user and authorize the user to access the webpage.

10. The method of claim 9, wherein the at least one processor is further configured to generate an electronic journal corresponding to the user when the membership account is generated.

11. The method of claim 8, wherein the reading display comprises the reading resource menu, wherein the at least one selectable option corresponds to the at least one book, and wherein the at least one selectable option includes at least one of vocabulary terms, phonics lessons, self-assessments, reading voices, and choose-your-adventures.

12. The method of claim 8, wherein the reading display further comprises Ask link interface comprising one or more data fields to receive one or more questions corresponding to the at least one book as input from the user.

13. The method of claim 8, wherein automatically hyperlinking, at least one term included in at least one page of the plurality of pages to at least one selectable option of a reading resource menu, based on the learning ability of the user comprises:
determining a reading level of the user; and
identifying the term based on the reading level.

14. The method of claim 8, wherein the window is a pop-up window external to the reading display.

15. A non-transitory computer readable medium encoded with instructions for performing electronic education, the instructions, executable by a processor, comprising:
serving a webpage comprising a reading display to present at least one book to a user, the book comprising a plurality of pages;
based on a learning ability of the user, hyperlinking at least one term included in at least one page of the plurality of pages to at least one selectable option of a reading resource menu included in the webpage;
displaying the hyperlinked at least one term on the reading display during presentation of the at least one page to enable access to the term; and
displaying on the reading display, a window corresponding to the at least one selectable option, when the hyperlink is accessed.

16. The non-transitory computer readable medium of claim 15, wherein the at least one processor is further configured to process membership information corresponding to the user to generate a unique membership account corresponding to the user and authorize the user to access the webpage.

17. The non-transitory computer readable medium of claim 16, wherein the at least one processor is further configured to generate an electronic journal corresponding to the user when the membership account is generated.

18. The non-transitory computer readable medium of claim 15, wherein the reading display comprises the reading resource menu, wherein the at least one selectable option corresponds to the at least one book, and wherein the at least one selectable option includes at least one of vocabulary terms, phonics lessons, self-assessments, reading voices, and choose-your-adventures.

19. The non-transitory computer readable medium of claim 15, wherein the reading display further comprises Ask link interface comprising one or more data fields to receive one or more questions corresponding to the at least one book as input from the user.

20. The non-transitory computer readable medium of claim 15, wherein the window is a pop-up window external to the reading display.
